(19) United States
(12) Patent Application Publication
(10) Pub. No.: US 2014/0035808 A1
(43) Pub. Date: Feb. 6, 2014

(54) ELECTRONIC DEVICE AND METHOD FOR REGULATING DISPLAY SCREEN

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 13/949,235

(22) Filed: Jul. 24, 2013

(30) Foreign Application Priority Data
Aug. 6, 2012 (TW) 101128332

(51) Int. Cl. G06F 3/01

(52) U.S. Cl. CPC G06F 3/012
USPC 345/156

(57) ABSTRACT

In a method for regulating the display on a screen of an electronic device, an initial state of a headpiece on a user is detected when the electronic device is powered on, and any deviation direction or deviation angle of the headpiece is determined by comparing a current orientation of the headpiece and an initial state thereof. A regulating direction and a regulating angle of the display screen or a displayed image on the display screen are determined according to any deviation direction and deviation angle such that when a deviation angle is greater than a threshold value, the physical display screen itself or the displayed image is adjusted according to the determined regulating direction and the determined regulating angle.

### BACKGROUND

1. Technical Field

Embodiments of the present disclosure relate to data display technology, and particularly to an electronic device and method for regulating a display screen of an electronic device.

2. Description of Related Art

Images are often displayed on a display screen of an electronic device (e.g., smart television) with an unchanged orientation (e.g., a horizontal orientation). A viewing angle cannot be changed according to any movement of a user's head. For example, when the user lies on a sofa, the viewing angle is not consistent with a display angle of the images on the smart television, which results in a uncomfortable vision after a long time watching. Therefore, a prompt and efficient method for regulating a display screen of an electronic device is desired.

### BRIEF DESCRIPTION OF THE DRAWINGS

FIG. 1 is a schematic diagram of one embodiment of an electronic device including a display screen regulating system.

FIG. 2 is a schematic diagram of function modules of the display screen regulating system included in the electronic device.

FIG. 3 is a flowchart of one embodiment of a method for regulating a display screen of the electronic device.

FIG. 4 is a schematic diagram of an example of a headpiece.

FIG. 5 is a schematic diagram of an example of a first adjustment mode for adjusting the display screen of the electronic device.

FIG. 6 is a schematic diagram of an example of a second adjustment mode for adjusting an image displayed on the display screen of the electronic device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

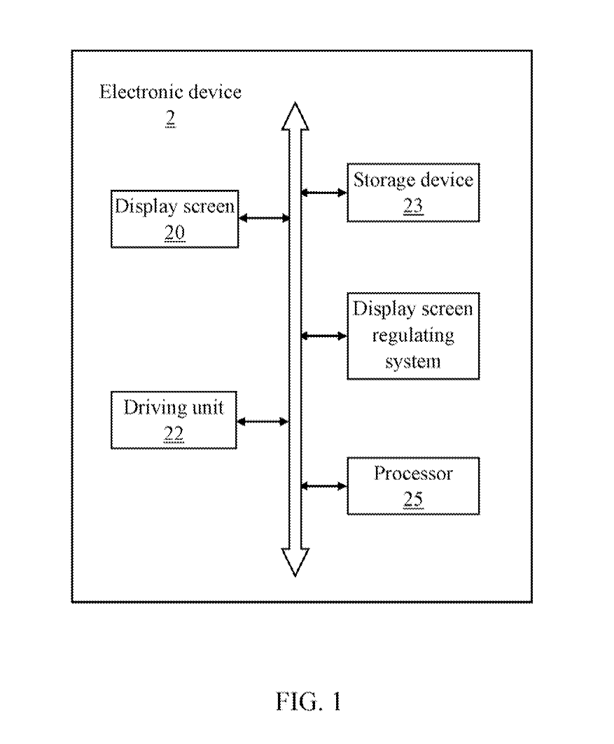

FIG. 1 is a block diagram of one embodiment of an electronic device 2 including a display screen regulating system 24. The electronic device 2 further includes a display screen 20, a driving unit 22, a storage device 23, and at least one processor 25. FIG. 1 illustrates only one example of the electronic device 2 that may include more or fewer components than illustrated, or have a different configuration of the various components in other embodiments. The electronic device 2 may be a smart television (TV), and the display screen 20 may be a liquid crystal display (LCD) screen of the smart TV.

The driving unit 22 is positioned on the back (or on the bottom) of the electronic device 2, the driving unit 22 controls movements of the electronic device 2. For example, the driving unit 22 may be a servomotor which includes an X-axis driving motor, a Y-axis driving motor, and an Z-axis driving motor. The storage device 23 may be a smart media card, a secure digital card, a compact flash card, or any other memory storage device. The storage device 23 stores source codes of the display screen regulating system 24.

The display screen regulating system 24 can rotate the display screen 20 or can rotate an image displayed on the display screen 20 (displayed image) according to movements of a user's head. A detailed description is given in the following paragraphs. In one embodiment, the display screen regulating system 24 includes computerized instructions in the form of one or more programs that are executed by the processor 25 and stored in the storage device 23 (or memory).

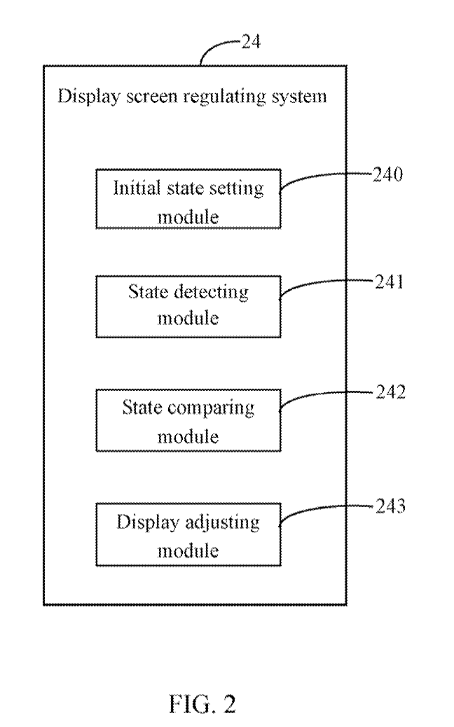

FIG. 2 is a block diagram of function modules of the display screen regulating system 24 included in the electronic device 2. In one embodiment, the display screen regulating system 24 may include one or more modules, for example, an initial state setting module 240, a state detecting module 241, a state comparing module 242, and a display adjusting module 243. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

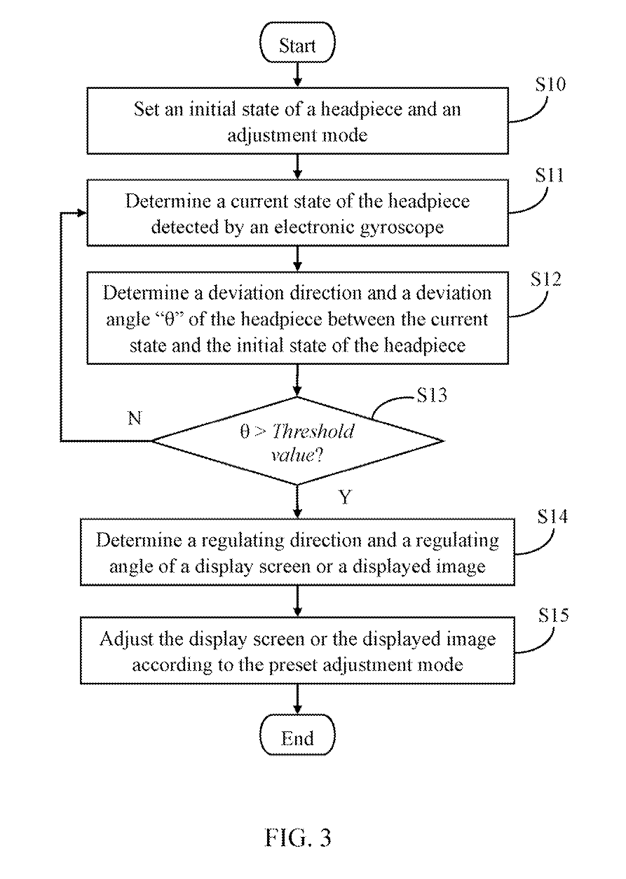

FIG. 3 is a flowchart of one embodiment of a method for regulating the display screen 20 of the electronic device 2. Depending on the embodiment, additional steps may be added, others removed, and the ordering of the steps may be changed.

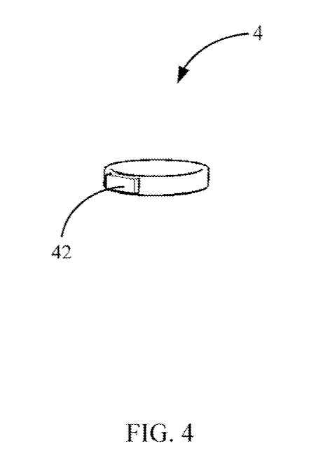

In step S10, a headpiece 4 (or other suitable head equipment) is worn on a head of a user, and a user setting interface is displayed on the display screen 20 by operating a remote controller of the electronic device 2. In one embodiment, the headpiece 4 is an elastic ring, and an electronic gyroscope 42 is installed on the headpiece 4 (referring to FIG. 4). The electronic gyroscope 42 is used for detecting a state (e.g., a direction and an angle in relation to the electronic device 2) of the headpiece 4 at preset time intervals (e.g., five seconds). For example, the electronic gyroscope 42 may be a two-axis gyroscope or a three-axis gyroscope.

The initial state setting module 240 sets an initial state of the headpiece 4 and an adjustment mode of the display screen 20 in response to user input on the user setting interface. When the user press a confirm button (e.g., an “OK” button) on the remote controller of the electronic device 2, the initial state setting module 240 stores the setting information of the initial state and the adjustment mode into the storage device 23 of the electronic device 2. In one embodiment, the initial state corresponds to an initial angle and an initial direction or other parameters of the headpiece 4 which are taken as a baseline configuration by the electronic gyroscope 42, when a viewing angle of the user is consistent with a display angle of the image displayed on the display screen 20.

In one embodiment, the adjustment mode may include, but is not limited to, a first adjustment mode for adjusting the display screen 20 of the electronic device 2 (a hardware adjustment mode), and a second adjustment mode for adjusting the image displayed on the display screen 20 (displayed image) by adjusting the display of any image on the display screen 20 of the electronic device 2 (a software adjustment mode).

In step S11, the state detecting module 241 determines a current state of the headpiece 4 (e.g., a current state of the user's head) by reference to the electronic gyroscope 42, at preset time intervals (e.g., five seconds). In one embodiment, the current state of the headpiece 4 corresponds to a current angle and a current direction of the headpiece 4 which are sensed by the electronic gyroscope 42. In other embodiments, the initial state or the current state of the headpiece 4 may be detected by other electronic components, such as an electronic compass installed on the headpiece 4.

In step S12, the state comparing module 242 determines any deviation in terms of direction and angle (deviation direction and deviation angle “θ”) of the headpiece 4 between the current state and the initial state of the headpiece 4. For example, the state comparing module 242 determines a deviation direction and a deviation angle related with the initial state of the headpiece 4 by comparing the initial angle with the current angle of the headpiece 4 and comparing the initial direction with the current direction of the headpiece 4.

In step S13, the display adjusting module 243 determines whether the deviation angle “θ” is greater than a threshold value (e.g., five degrees). If the deviation angle “θ” is greater than the threshold value, the procedure goes to step S14. If the deviation angle “θ” is less than or equal to the threshold value, the procedure returns to step S11.

In step S14, to order to adjust the orientation of the display screen 20 or the images displayed thereupon (displayed images), the display adjusting module 243 determines a regulating direction and a regulating angle of the display screen 20 or the displayed image according to a deviation direction and a deviation angle of the headpiece 4. If the preset adjustment mode is the first adjustment mode, the determined regulating direction and regulating angle are the regulating direction and the regulating angle of the display screen 20. If the preset adjustment mode is the second adjustment mode, the determined regulating direction and regulating angle are the regulating direction and the regulating angle for the modulation or canting of the displayed image. For example, if the headpiece 4 moves thirty degrees leftward, the display adjusting module 243 determines that the regulating direction of the display screen 20 or the displayed image is left, and the regulating angle is thirty degrees.

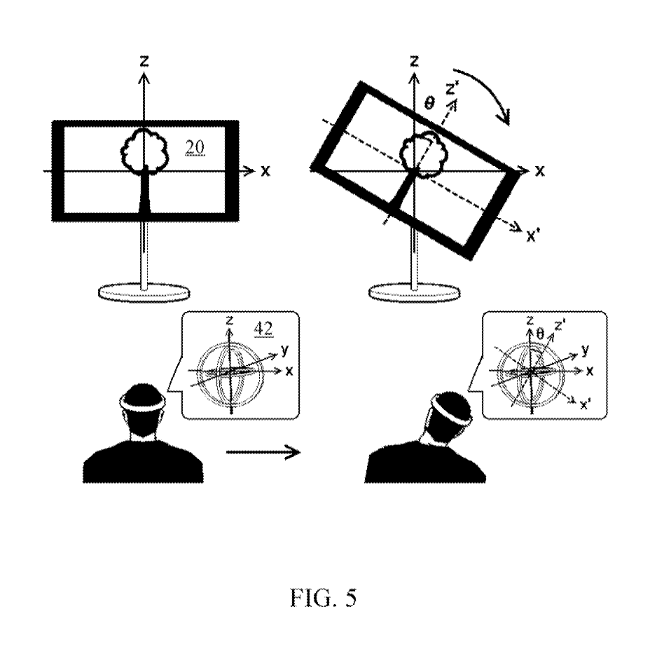

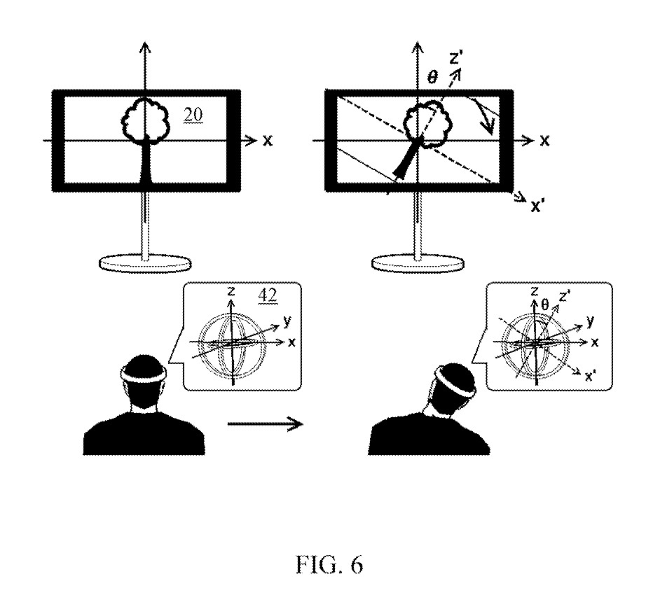

In step S15, the display adjusting module 243 adjusts a physical orientation of the display screen 20 or a display orientation of the displayed image according to the determined regulating direction, the determined regulating angle, and the preset adjustment mode, such that a display angle of the image on the display screen 20 is consistent with a user's viewing angle. In one embodiment, the adjustment operation of the display screen 20 or the displayed image is performed in an X-Z plane of the display screen 20 or the displayed image (referring to FIG. 5 and FIG. 6).

If the preset adjustment mode is the first adjustment mode, the display adjusting module 243 orientates or re-orientates the display screen 20 with the determined regulating angle (e.g., thirty degrees) according to the determined regulating direction of the display screen 20, such that a line between the eyes is parallel to (or nearly parallel to) a display direction of the display screen 20 (i.e., the viewing angle of the user is consistent with the display angle of the image displayed on the display screen 20). In one embodiment, the display adjusting module 243 controls the display screen 20 to rotate using the driving unit 22 of the electronic device 2. For example, as shown in FIG. 5, “θ” represents the deviation angle of headpiece 4, the regulating angle of the display screen 20 is also determined as “θ” (the displayed image on the display screen 20 is not rotated), so that the viewing angle of the user is consistent with the display angle of the image on the display screen 20.

If the preset adjustment mode is the second adjustment mode, the display adjusting module 243 rotates the displayed image on the display screen 20 with the determined regulating angle (e.g., thirty degrees) according to the determined regulating direction, such that the line between the eyes is parallel to (or nearly parallel to) a display direction of the image on the display screen 20 (i.e., the viewing angle of the user is consistent with the display angle of the image displayed on the display screen 20). For example, as shown in FIG. 6, “θ” represents the deviation angle of headpiece 4, the regulating angle of the displayed image on the display screen 20 is also determined as “θ” (the display screen 20 is not physically moved or rotated), so that the viewing angle of the user is consistent with the angle of display (from the horizontal) of the image on the display screen 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for regulating a display screen of an electronic device, the method comprising:
detecting a current state of a head equipment on a user's head when the electronic device is powered on;
determining a deviation direction and a deviation angle of the head equipment by comparing the current state of the head equipment with an initial state of the head equipment;
determining a regulating direction and a regulating angle of the display screen or a displayed image on the display screen according to the deviation direction and the deviation angle when the deviation angle is greater than a threshold value; and
adjusting the display screen or the displayed image according to the determined regulating direction, the determined regulating angle, and a preset adjustment mode.

2. The method according to claim 1, further comprising:
setting the initial state of the head equipment and the adjustment mode of the display screen, and storing information of the initial state and the adjustment mode in a storage device of the electronic device.

3. The method according to claim 1, wherein the initial state of the head equipment corresponds to an initial angle and an initial direction of the head equipment, and the current state of the head equipment corresponds to a current angle and a current direction of the head equipment.

4. The method according to claim 1, wherein the step of adjusting the display screen or the displayed image comprises:
rotating the display screen with the determined regulating angle using a driving unit of the electronic device according to the determined regulating direction when the preset adjustment mode is a first adjustment mode.

5. The method according to claim 1, wherein the step of adjusting the display screen or the displayed image comprises:
rotating the displayed image on the display screen with the determined regulating angle according to the determined regulating direction when the preset adjustment mode is a second adjustment mode.

6. An electronic device, comprising:
a processor;
a display screen;
a storage device storing a plurality of instructions, which when executed by the processor, causes the processor to:
detect a current state of a head equipment on a user's head when the electronic device is powered on;
determine a deviation direction and a deviation angle of the head equipment by comparing the current state of the head equipment with an initial state of the head equipment;
determine a regulating direction and a regulating angle of the display screen or a displayed image on the display screen according to the deviation direction and the deviation angle when the deviation angle is greater than a threshold value; and
adjust the display screen or the displayed image according to the determined regulating direction, the determined regulating angle, and a preset adjustment mode.

7. The electronic device according to claim 6, wherein the plurality of instructions further comprise:
setting the initial state of the head equipment and the adjustment mode of the display screen, and storing information of the initial state and the adjustment mode in a storage device of the electronic device.

8. The electronic device according to claim 6, wherein the initial state of the head equipment corresponds to an initial angle and an initial direction of the head equipment, and the current state of the head equipment corresponds to a current angle and a current direction of the head equipment.

9. The electronic device according to claim 6, wherein the instruction of adjusting the display screen or the displayed image comprises:
rotating the display screen with the determined regulating angle using a driving unit of the electronic device according to the determined regulating direction when the preset adjustment mode is a first adjustment mode.

10. The electronic device according to claim 6, wherein the instruction of adjusting the display screen or the displayed image comprises:
rotates the displayed image on the display screen with the determined regulating angle according to the determined regulating direction when the preset adjustment mode is a second adjustment mode.

11. A non-transitory storage medium having stored thereon instructions that, when executed by a processor of a electronic device, causes the electronic device to perform a method for regulating a display screen of the electronic device, the method comprising:
detecting a current state of a head equipment on a user's head when the electronic device is powered on;
determining a deviation direction and a deviation angle of the head equipment by comparing the current state of the head equipment with an initial state of the head equipment;
determining a regulating direction and a regulating angle of the display screen or a displayed image on the display screen according to the deviation direction and the deviation angle when the deviation angle is greater than a threshold value; and
adjusting the display screen or the displayed image according to the determined regulating direction, the determined regulating angle, and a preset adjustment mode.

12. The non-transitory storage medium according to claim 11, wherein the method further comprises:
setting the initial state of the head equipment and the adjustment mode of the display screen, and storing information of the initial state and the adjustment mode in a storage device of the electronic device.

13. The non-transitory storage medium according to claim 11, wherein the initial state of the head equipment corresponds to an initial angle and an initial direction of the head equipment, and the current state of the head equipment corresponds to a current angle and a current direction of the head equipment.

14. The non-transitory storage medium according to claim 11, wherein the step of adjusting the display screen or the displayed image comprises:
rotating the display screen with the determined regulating angle using a driving unit of the electronic device according to the determined regulating direction when the preset adjustment mode is a first adjustment mode.

15. The non-transitory storage medium according to claim 11, wherein the step of adjusting the display screen or the displayed image comprises:
rotating the displayed image on the display screen with the determined regulating angle according to the determined regulating direction when the preset adjustment mode is a second adjustment mode.
